(19) United States
(12) Patent Application Publication
(10) Pub. No.: US 2003/0068411 A1
(43) Pub. Date: Apr. 10, 2003

(54) Microvaveable pasta product

(76) Inventors: Patrick E. McCallister, Corona, CA (US); Thomas W. Osip, Mission Viejo, CA (US); Nikia J. Hyman, Irvine, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/965,300

(22) Filed: Sep. 28, 2001

(51) Int. Cl. A23B 4/00

(52) U.S. Cl. 426/107

(57) ABSTRACT

A microwaveable pasta product is provided. The product comprises a dried pasta product in a microwaveable container. The microwaveable container comprises a bowl having a generally-ovular bottom and a generally-ovular outer wall in generally-perpendicular relation to the circumference of the generally-ovular bottom. The bottom and outer wall together define a cavity in which the dried pasta product is contained. The container accommodates foam expansion without sacrificing product appearance or shelf space.

### FIELD OF THE INVENTION

The present invention is directed to a microwaveable pasta product in an improved microwaveable container.

### BACKGROUND

Consumers are increasingly demanding more convenient food products that can be quickly and easily prepared. One such product is a pasta product that includes dried pasta that can be reconstituted and cooked in the presence of hot water, which is often provided as a single-serving product. However, a significant problem with such products is that, when the water is heated in the container with the pasta product, foam expansion occurs. If the container does not have a sufficient volume to accommodate the foam expansion, the water boils over the sides of the container, which is undesirable to consumers.

However, there are also drawbacks to selling the pasta product in a larger container that can accommodate the foam expansion. First, larger containers take up more space on grocery store shelves and in boxes for shipment and storage. Additionally, once the pasta product is cooked, the product does not have a full appearance due to the larger container, which is also undesirable to consumers.

One approach to obviating these problems is to provide a pasta product to the consumer in a disposable container that is sufficiently small for purposes of storage and shipment, as well as product appearance. The consumer then transfers the pasta product from disposable container to a larger bowl or container in the consumer's home in which the consumer can add water, cook the product and avoid boil over. This approach is obviously undesirable, as it creates an additional step for the consumer.

Another approach to obviating these problems is to provide a pasta product to the consumer in a container to which the consumer adds pre-boiled water. However, with this approach, the water that is not absorbed by the pasta product does not boil off, thus leaving the pasta product sitting in excess water, which is undesirable to consumers.

### SUMMARY OF THE INVENTION

The present invention addresses the above concerns by providing a microwaveable pasta product in an improved microwaveable container in which water can be added directly to the pasta product for cooking. The container accommodates foam expansion without sacrificing a full bowl appearance or shelf space.

In one embodiment, the invention is directed to a microwaveable pasta product. The product comprises a dried pasta product and a microwaveable container. The microwaveable container comprises a bowl having a generally-ovular bottom with a circumference and a generally-ovular outer wall in generally-perpendicular relation to the circumference of the generally-ovular bottom. The bottom and outer wall together define a cavity in which the dried pasta product is contained.

During cooking, the generally-ovular geometry of the dish provides product containment and uniform heating in the corners and center of the product mass, while maintaining a full appearance after preparation. The area of the dish accommodates the foam expansion that is experienced during the cooking cycle in the microwave, while the volume of the dish is held to a minimum to provide an element of portability and a full bowl appearance.

In another embodiment, the invention is directed to a method for preparing a pasta product. The method comprises providing a dried pasta product in a microwaveable container having a generally-ovular bottom and a generally-ovular outer wall in generally-perpendicular relation to the circumference of the generally-ovular bottom. The bottom and outer wall together define a cavity in which the dried pasta product is contained. The container further comprises a top that covers the cavity. The top is removed from the microwaveable container, and water is introduced into the cavity of the container. The dried pasta product and water in the container without the top are exposed to microwave energy to produce a cooked pasta product.

### DESCRIPTION OF THE DRAWINGS

These and other features of the advantages of the present invention will be better understood by reference to the following detailed description when considered in conjunction with the accompanying drawings wherein:

FIG. 1 is a top view of a container in accordance with the invention.

FIG. 2 is an end cross-sectional view of the container of FIG. 1 across line 2-2.

FIG. 3 is a side cross-sectional view of the container of FIG. 1 across line 3-3.

FIG. 4 is a side cross-sectional view of a wall of the container of FIG. 1 across line 4-4.

FIG. 5 is an end cross-sectional view of a wall of the container of FIG. 1 across line 5-5.

### DETAILED DESCRIPTION

The invention is thus directed to an improved microwaveable pasta product. The product comprises a dried pasta product contained within a microwaveable bowl that is designed to minimize or eliminate boil-over while not detracting from the product appearance.

Microwaveable, thin-walled dried pasta products that can be reconstituted to a cooked state upon absorbing water during microwaving can be used in accordance with the invention. Such microwaveable dried pasta products are commercially available, for example, under the brand name MUELLER'S from Unilever Bestfoods.

The container can be made from any suitable heat resistant material that is substantially transparent to microwaves, while concurrently being liquid-impervious. The container preferably comprises a disposable, and more preferably an inexpensive, material, more preferably a plastic that can be produced by thermoforming or other like technique. A particularly preferred plastic suitable for use in connection with the present invention is crystallized polyethylene terephthalate (CPET).

Preferably the container comprises a bowl having a wall thickness less than about 0.4 inch, more preferably less than about 0.3 inch, still more preferably about 0.2 inch. Even more preferably the container consists essentially of a bowl having such a thickness, and does not include any additional features, such as an insulating foam shell made of polyurethane or the like.

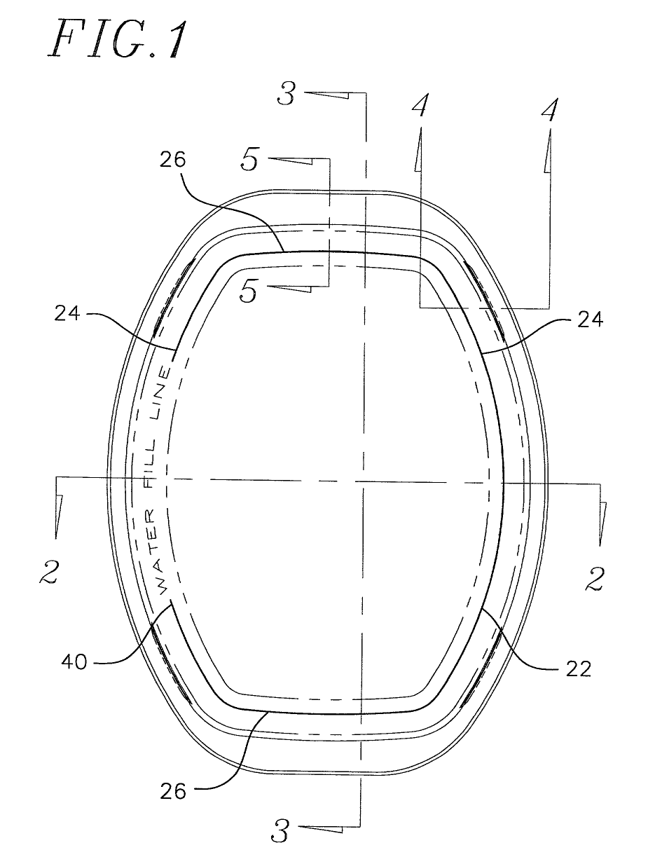

As shown in FIGS. 1 to 3, the container comprises a bowl having a generally-ovular bottom 20 and a generally-ovular outer wall 22 in generally-perpendicular relation to the circumference of the generally-ovular bottom. The bottom 20 and outer wall 22 together define a cavity 23 in which the dried pasta product (not shown) is contained. The generally-ovular bottom 20 and generally-ovular outer wall 22 each have a “circumference” that is generally-ovular in that its length is greater than its width, its width is greatest at approximately the midpoint of its length, and its width decreases along its length going outward from the midpoint of its length. In the depicted embodiment, the outer wall 22 is formed from two generally curved sidewalls 24 and two generally straight end walls 26, with the end walls being shorter than the sidewalls. Alternatively, the outer wall 22 be formed of a continuous curved wall, a series of generally-straight walls, such as an elongated hexagon, or any other combination of curved and straight walls that conforms with the above definition of generally-ovular. The bottom 20 preferably has a circumference that substantially corresponds to the circumference of the bottom of the curved wall 22, i.e., the portion of the curved wall that contacts the bottom. As used herein, the term “circumference” is not limited to the outer boundary of a circular area, but includes the outer periphery of the bottom 20 or the outer wall 22 having a generally-ovular shape as described above, even if the generally-ovular shape includes straight regions.

The cavity preferably has a length to width ratio, as measured at the top of the cavity, of at least about 1.2:1, preferably at least about 1.3:1. Preferably the cavity is generally symmetrical, i.e., is symmetrical over its longitudinal axis and over its lateral axis. Preferably the cavity has a length, as measured at the top of the cavity, ranging from about 6 inches to about 10 inches, more preferably ranging from about 7 inches to about 9 inches, and the cavity has a width, as measured at the top of the cavity, ranging from about 5 inches to about 8 inches, more preferably from about 5.5 inches to about 6.5 inches.

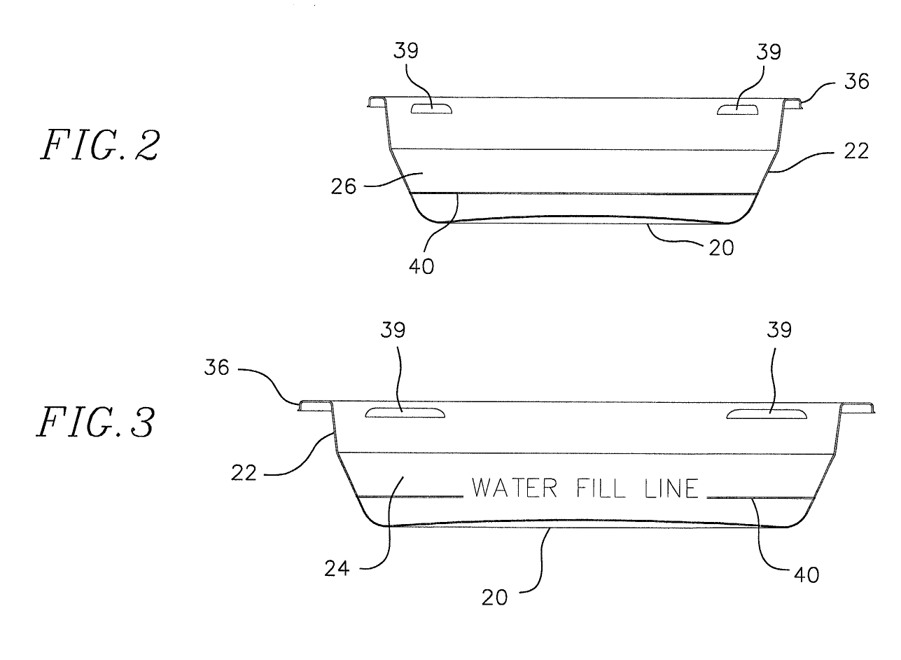

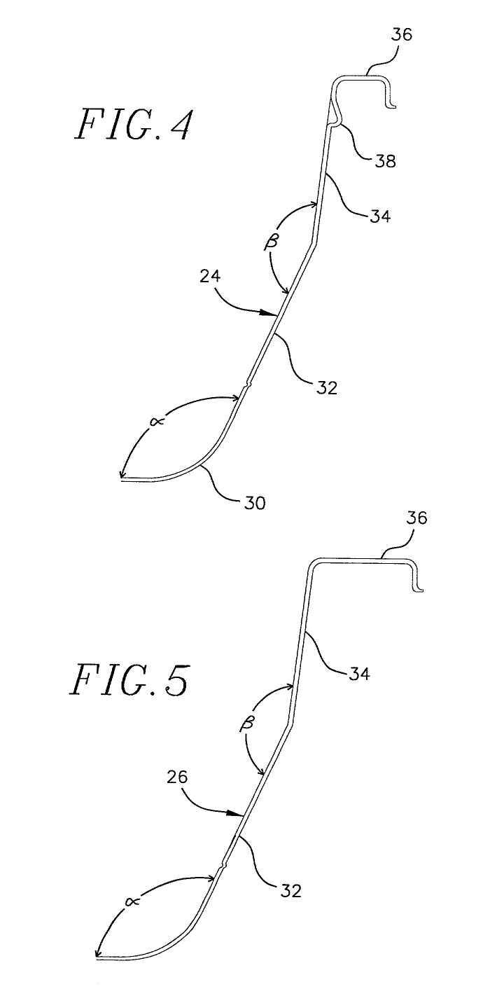

Preferably the area of the cavity varies over the height of the cavity. As can be seen in FIGS. 2 and 3, which depict a preferred embodiment of the invention, the outer wall 22 flares outwardly over its height. More specifically, as shown in FIGS. 4 and 5, the outer wall 22 comprise a generally rounded corner 30 that joins the outer wall to the bottom 20, a generally straight bottom region 32 extending outwardly from the rounded corner so as to form an obtuse angle α with the bottom, and a generally straight upper region 34 extending outwardly from the bottom region at an obtuse angle β with the bottom that it greater than the angle α. The angle α preferably is from about 110° to about 130°, more preferably about 120°. The angle β preferably is from about 150° to about 170°, more preferably about 162°, to keep the size of the dish at a reasonable size. Additionally, it is preferred that the straight upper region 34 is not perpendicular with the horizontal, which would make it difficult to de-nest stacked containers. Other outer wall 22 designs whereby the wall generally flares outwardly so that the area of the cavity varies over the height of the cavity can be provided in accordance with this preferred embodiment. This design provides a full looking package after the cooking cycle.

The cavity is covered by a top or cover (not shown), to contain the pasta product in the container during shipping and storage. Preferably the top comprises a flexible film, as is generally known in the art, that is vacuum-sealed over the top of the container. A particularly preferred material for the film is polyethylene terephthalate.

In the depicted embodiment, a lip 36 extends around the bowl in generally perpendicular relation to the top of the outer wall 22. The lip 36 assists the user in gripping the container during use. Preferably the lip 36 is wider along the end walls 26 than along sidewalls 24 because users tend to prefer to grip generally-ovular containers of all sorts nearer the end walls. Accordingly, the lip 36 is not as wide around the side walls 24 to reduce the size of the product for more efficient storage. Preferably the lip 36 has a width ranging from about 0.5 to about 1.5 inches along the end walls 26 and a width ranging from about 0.2 to about 0.8 inch along the side walls 24.

Preferably at least a portion of the outer wall 22 includes a stack lug configuration. For example, as shown in FIGS. 2, 3 and 4, the side walls 24 each include two protrusions 38 or other deformity a short distance below the lip 36. When one container is stacked inside another container, the protrusions 38 limit how close the containers can come to each other. More specifically, when one container is nested in another container, the protrusions 38 of the upper container contact the lip 36 of the lower container, thereby providing a small space (e.g., 0.1 to 0.4 inch) between the lips for easier separation during manufacturing operations. Other suitable designs to eliminate sticking during nesting could be incorporated into the inventive container in addition to or instead of that described above.

In use, a dried pasta product in a microwaveable container having a design as described above is provided. The amount of dried pasta can vary as desired, but preferably ranges from about 600 g to about 1000 g, and more preferably is about 758 g. The consumer removes the top of the microwaveable container and pours or otherwise introduces water into the cavity of the container. Preferably the container is provided with a “WATER FILL LINE” 40 to generally indicate to the user how much water should be added, which in a preferred embodiment is approximately two-thirds of a cup. In the depicted embodiment, the “WATER FILL LINE” 40 is provided on the inside of the container. With the top still off the container, the dried pasta product and water in the container is exposed to microwave energy. Preferred cooking times range from about 2 minutes to about 5 minutes, more preferably from about 3 minutes to about 4 minutes, but can vary depending on the type of microwave oven used.

In a particularly preferred embodiment, a packet of sauce is sold in combination with the dried pasta product in the container. After the dried pasta product has been exposed to microwave energy for a time sufficient to cook the product, the sauce in the packet is poured over the pasta by consumer. It is typically unnecessary for the consumer to heat the sauce before pouring it over the pasta product, because the pasta product is usually sufficiently hot to heat the sauce to a desired temperature upon application. The sauce packet can include just a flavored sauce (such as a cheese or marinara sauce) or can include a sauce in combination with meat and/or vegetables, as is generally known in the art.

The preceding description has been presented with reference to presently preferred embodiments of the invention. Workers skilled in the art and technology to which this invention pertains will appreciate that alterations and changes in the described product and method may be practiced without meaningfully departing from the principal, spirit and scope of this invention. Accordingly, the foregoing description and accompanying drawings should not be read as pertaining only to the precise products and methods described, but rather should be read consistent with and as support to the following claims which are to have their fullest and fair scope.

What is claimed is:

1. A microwaveable pasta product comprising:
a dried pasta product; and
a microwaveable container comprising a bowl having a generally-ovular bottom and a generally-ovular outer wall in generally-perpendicular relation to the circumference of the generally-ovular bottom, wherein the bottom and outer wall together define a cavity in which the dried pasta product is contained.

2. The microwaveable pasta product of claim 1, wherein the cavity has a length to width ratio of at least about 1.2:1.

3. The microwaveable pasta product of claim 1, wherein the cavity has a length to width ratio of at least about 1.3:1.

4. The microwaveable pasta product of claim 1, wherein the cavity is generally symmetrical.

5. The microwaveable pasta product of claim 1, wherein the cavity has a length ranging from about 6 inches to about 10 inches.

6. The microwaveable pasta product of claim 5, wherein the cavity has a width ranging from about 5 inches to about 8 inches.

7. The microwaveable pasta product of claim 1, wherein the cavity has a length ranging from about 7 inches to about 9 inches.

8. The microwaveable pasta product of claim 7, wherein the cavity has a width ranging from about 5.5 inches to about 6.5 inches.

9. The microwaveable pasta product of claim 1, wherein the area of the cavity varies over the height of the cavity.

10. The microwaveable pasta product of claim 1, wherein at least a portion of the circumference of the bottom is curved.

11. The microwaveable pasta product of claim 1, wherein the container has a thickness less than about 0.4 inch.

12. The microwaveable pasta product of claim 1, wherein the container has a thickness less than about 0.3 inch.

13. The microwaveable pasta product of claim 1, wherein the container consists essentially of a bowl having a thickness less than about 0.4 inch.

14. A method for preparing a pasta product comprising:
providing a dried pasta product in a microwaveable container having a generally-ovular bottom, a generally-ovular outer wall in generally-perpendicular relation to the circumference of the generally-ovular bottom, wherein the bottom and outer wall together define a cavity in which the dried pasta product is contained, and a top that covers the cavity;
removing the top from the microwaveable container;
introducing water into the cavity of the container; and
exposing the dried pasta product and water in the container without the top to microwave energy to produce a cooked pasta product.

15. The method of claim 14, further comprising pouring a sauce over the cooked pasta product.
